(19) United States
(12) Patent Application Publication
(10) Pub. No.: US 2007/0214981 A1
(43) Pub. Date: Sep. 20, 2007

(54) Sheet-fed printing machine

(75) Inventors: Jurgen Michels, Dossenheim (DE); Dieter Schaffrath, Lorsch (DE); Wolfgang Schonberger, Schriesheim (DE); Bernhard Schwaab, Neustadt (DE); Michael Thielemann, Heidelberg (DE)

Correspondence Address: LERNER GREENBERG STEMER LLP, P O BOX 2480, HOLLYWOOD, FL, 33022-2480, US

(73) Assignee: Heidelberger Druckmaschinen AG

(21) Appl. No.: 11/724,139

(22) Filed: Mar. 14, 2007

Related U.S. Application Data
(60) Provisional application No. 60/782,003, filed on Mar. 14, 2006.

(30) Foreign Application Priority Data
Mar. 15, 2006 (DE) 10 2006 011 859.6

(51) Int. Cl. B41F 31/00

(52) U.S. Cl. 101/350.1

(57) ABSTRACT

A sheet-fed printing machine includes an anilox inking unit having a screen roller and an ink applicator roller, as well as a dampening unit having a dampener applicator roller. The ink applicator roller has an outside diameter which is more than twice as large as the outside diameter of the dampener applicator roller.

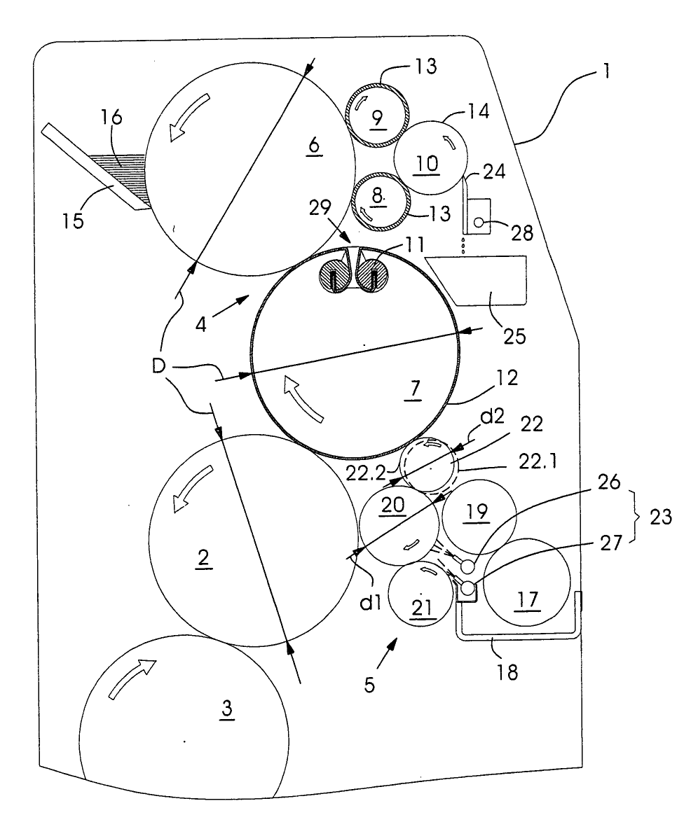

### CROSS-REFERENCE TO RELATED APPLICATION

This application claims the priority of U.S. Provisional Patent Application No. 60/782,003, filed Mar. 14, 2006 and German Patent Application DE 10 2006 011 859.6, filed Mar. 15, 2006, under 35 U.S.C. §119; the prior applications are herewith incorporated by reference in their entirety.

### BACKGROUND OF THE INVENTION

### Field of the Invention

The present invention relates to a sheet-fed printing machine, including an anilox inking unit having a screen roller and an ink applicator roller, and a dampening unit having a dampening or dampener applicator roller.

German Patent DE 42 11 379 C2, corresponding to U.S. Pat. No. 5,355,796, describes a printing machine including an anilox inking unit having a screen roller and an inking or ink applicator roller, and a dampening unit having a dampener applicator roller. Since a rubber blanket cylinder of that printing machine may be in contact with a further rubber blanket cylinder, it is to be presumed that the printing machine is a web-fed printing machine. The drawing in the afore-mentioned patent diagrammatically illustrates an ink applicator roller and a dampener applicator roller and offers no suggestion as to any significance of roller diameters. Washing of the anilox inking unit and the dampening unit also plays no role in the patent.

It is known from practice that, in contrast with web-fed printing machines, there is a more frequent requirement in sheet-fed printing machines for washing the inking and dampening units because of the more rapid sequence of different printing orders and the ink changes associated therewith. In order for such washing to require only the briefest possible printing interruptions and to take place with a low consumption of washing agent, the aim is to achieve a rapid and uniform distribution of the washing agent being introduced.

### SUMMARY OF THE INVENTION

It is accordingly an object of the invention to provide a sheet-fed printing machine, which overcomes the hereinafore-mentioned disadvantages of the heretofore-known devices of this general type and which provides structural preconditions for effective washing in a sheet-fed printing machine, which includes an anilox inking unit having a screen roller and an ink applicator roller, and a dampening unit having a dampener applicator roller. In particular, it is an object of the invention, in such a sheet-fed printing machine, to achieve a rapid and uniform distribution of the washing agent.

With the foregoing and other objects in view, there is provided, in accordance with the invention, a sheet-fed printing machine comprising an anilox inking unit having a screen roller and an ink applicator roller, and a dampening unit having a dampener applicator roller. The ink applicator roller has an outside diameter which is more than twice as large as an outside diameter of the dampener applicator roller.

Due to the fact that the circumferential length of the dampening applicator roller consequently amounts to less than half the circumferential length of the ink applicator roller, the dampener applicator roller executes several revolutions for each revolution of the ink applicator roller. Accordingly, beneficial structural preconditions for a uniform distribution of the washing agent in the dampening unit and in the anilox inking unit are provided.

In accordance with another feature of the invention, the ink applicator roller and the dampener applicator roller have respective outer diameters which are in a ratio amounting to at least 10:4.

In accordance with a further feature of the invention, the sheet-fed printing machine, in a cleaning mode thereof, has a bridge roller bearing against the dampener applicator roller and against the ink applicator roller.

In accordance with an added feature of the invention, the bridge roller has an outside diameter, and the outside diameter of the ink applicator roller is more than twice as large as the outside diameter of the bridge roller.

In accordance with an additional feature of the invention, the outside diameter of the ink applicator roller and the outside diameter of the bridge roller are in a ratio amounting to at least 10:4.

In accordance with yet another feature of the invention, the sheet-fed printing machine further includes a jet or spray device, which serves for introducing a washing agent directed onto the dampening unit.

In accordance with yet a further feature of the invention, the sheet-fed printing machine further includes a dampening unit roller bearing only against the dampener applicator roller. The jet or spray device is directed onto the dampener applicator roller and/or the dampening unit roller bearing only against the dampener applicator roller.

In accordance with yet an added feature of the invention, the sheet-fed printing machine, in the cleaning mode, has a cleaning doctor blade coupled to the screen roller through at least one inking unit roller.

In accordance with yet an additional feature of the invention, the ink applicator roller is formed with a cylinder channel provided with a tensioning device for mounting a rubber blanket in tension on the ink applicator roller.

In accordance with a concomitant feature of the invention, the ink applicator roller is identical in diameter with a printing form cylinder with respect to the outside diameters thereof.

It is again noted that, in one development, the outside diameter of the ink applicator roller and the outside diameter of the dampening applicator roller are in a ratio which amounts to at least 10:4.

In a further development, in a cleaning mode, a bridge roller bears against the dampening applicator roller and against the ink applicator roller.

In an added development, the outside diameter of the ink applicator roller is more than twice as large as an outside diameter of the bridge roller.

In a further development, the outside diameter of the ink applicator roller and the outside diameter of the bridge roller are in a ratio which amounts to at least 10:4.

In an additional development, a jet or spray device for introducing a washing agent is directed onto the dampening unit.

In a further development, the jet or spray device is directed onto the dampening applicator roller and/or a dampening unit roller bearing only against the dampening applicator roller.

In an added development, in the cleaning mode, a cleaning doctor blade is coupled to the screen roller through at least one inking unit roller.

In a further development, the ink applicator roller includes a cylinder channel with a tensioning device for mounting a rubber blanket in tension on the ink applicator roller.

In an additional development, the ink applicator roller is identical in diameter to a printing form cylinder in terms of outside diameter.

In a further development, the washing agent is conveyed out of the dampening unit into the anilox inking unit by a bridge roller. The bridge roller predetermines the direction of the washing agent flow from the dampening unit into the inking unit.

Other features which are considered as characteristic for the invention are set forth in the appended claims.

Although the invention is illustrated and described herein as embodied in a sheet-fed printing machine, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawing.

### BRIEF DESCRIPTION OF THE DRAWING

The FIGURE of the drawing is a diagrammatic, cross-sectional view of a printing unit having an anilox inking unit and, for wet offset printing, a dampening unit.

### DESCRIPTION OF PREFERRED EMBODIMENTS

Referring now in detail to the single FIG. of the drawing, there is seen a printing machine 1 for offset printing, which includes a printing unit with a printing form cylinder 2, a rubber blanket cylinder 3, an anilox inking unit 4 and a dampening unit 5. The printing machine 1 is a sheet-fed printing machine. The anilox inking unit 4 includes a screen roller 6 and a single ink applicator roller 7, both identical in diameter to that of the printing form cylinder 2. The common outside diameter of the rollers 6 and 7 and of the printing form cylinder 2 is designated by reference character D. Moreover, the anilox inking unit 4 includes a first roller 8, a second roller 9 and a third roller 10. The first roller 8 and the second roller 9 bear against the screen roller 6, and the third roller 10 bears against the first roller 8 and against the second roller 9.

The ink applicator roller 7 has a tensioning device 11 for applying tension to a rubber blanket 12. The tensioning device 11 is seated in a cylinder channel 29 formed in the ink applicator roller 7.

The first roller 8 and the second roller 9 have respective elastomeric roller coverings 13 and ensure ghost-free printing. The elastomeric roller coverings 13 are advantageous in a cleaning mode of the printing machine 1, in that the roller coverings 13 are temporarily pressed into the depressions (wells or grooves) of the screen structure of the screen roller 6 and, during subsequent release from the screen structure, exert a suction effect by which printing ink seated in the depressions is conveyed out of the depressions. In specific applications, only one of the two rollers 8 and 9 need be present.

The third roller 10 has a metallic-hard circumferential surface which is formed by a rilsan layer 14. The third roller 10 is an axially traversing ink distributor roller and is rotationally driven by form-locking, i.e., by a gearwheel fixedly connected, in terms of rotation, to the third roller 10, and coaxially disposed therewith. It is noted, in this regard, that a form-locking connection is one which connects two elements together due to the shape of the elements themselves, as opposed to a force-locking connection, which locks the elements together by force external to the elements. In specific applications, the axial traversing movement of the third roller 10 is not absolutely necessary.

Furthermore, the anilox inking unit 4 includes an inking doctor blade (doctor-blade ink fountain) 15 which bears against the screen roller 6 and accommodates a printing-ink supply 16.

The dampening unit 5 includes a dipping roller 17 in a dampening-medium fountain 18, a metering roller 19, a dampener applicator roller 20 having an outside diameter d1, and an axially-traversing dampener distributor roller or dampening unit roller 21. The metering roller 19 bears, as a transfer roller, against the dipping roller 17 and, simultaneously, against the dampener applicator roller 20 when the printing machine 1 operates in a printing operating mode thereof (not illustrated in the drawing). In the cleaning mode thereof, the metering roller 19 is thrown off from the dampener applicator roller 20, as is illustrated in the FIGURE The dampener distributor roller 21 bears exclusively against the dampener applicator roller 20 and, in specific applications, does not necessarily have to traverse axially.

A bridge roller 22, having an outside diameter d2, is mounted so as to be selectively adjustable into a first position 22.1 and into a second position 22.2. In the first position 22.1 shown in phantom, the bridge roller 22 bears only against the dampener applicator roller 20, and is thrown off from the ink applicator roller 7. The bridge roller 22 assumes the first position 22.1 in the printing operating mode and assumes the second position 22.2 only in the cleaning mode. In the second position 22.2, which is illustrated by solid or unbroken lines, the bridge roller 22 bears against the dampener applicator roller 20 and, simultaneously, against the ink applicator roller 7 so that, in the cleaning mode, the dampening unit 5 is connected to the anilox inking unit 4 through the bridge roller 22.

In the cleaning mode, a system is used which includes a jet or spray device 23, for introducing a washing agent into the dampening unit 5, and a cleaning doctor blade 24 with a collecting trough 25 disposed therebeneath. The jet or spray device 23 includes a washing-agent spray tube 26 and a water spray tube 27. One of the spray tubes 26 or 27 is directed onto a respective one of the two rollers 20, 21, in the region of an entry nip or wedge formed by the dampener applicator roller 20 and the dampener distributor roller 21, and the other of the spray tubes 26, 27 is directed onto the respective other of the two rollers 20, 21. The jet or spray device 23 thus sprays the washing agent and the water into the entry nip or wedge. The cleaning doctor blade 24 is thrown onto the third roller 10 in the cleaning mode, and is thrown off of the latter in the printing operating mode. The throw-on and throw-off of the cleaning doctor blade 24 is effected by pivoting thereof about a swivel joint 28.

In order to perform the cleaning of the anilox inking unit 4, the printing machine 1 is operated as follows:

First, the dampener applicator roller 20 is thrown off of the printing form cylinder 2, and the bridge roller 22 is thrown onto the ink applicator roller 7 (second position 22.2). Moreover, the metering roller 19 is thrown off of the dampener applicator roller 20.

When the printing machine 1 is in operation, the washing agent is thereafter introduced by the jet or spray device 23 in several spray intervals into the entry nip or wedge between the dampener applicator roller 20 and the dampener distributor roller 21. A particularly effective cleaning can be achieved in such a way that, through the use of the jet or spray device 23, the washing agent is sprayed or jetted alternately with water onto the rollers 20 and 22 forming the entry nip or wedge. In specific applications, the water is not required, however, so that in these instances, the water spray tube 27 may be dispensed with.

Due to the rolling of the rollers 20 and 22 on one another, as is symbolized in the FIG. by arrows indicating the direction of rotation of the rollers 20 and 22, the washing agent is distributed in the entire anilox inking unit 4, and the washing agent is conveyed as far as the third roller 10.

In this regard, the washing agent flows over the bridge roller 22 onto the ink applicator roller 7, from the latter onto the screen roller 6 and from the latter, over the first roller 8 and the second roller 9, onto the third roller 10.

It has become apparent that a uniform distribution of the washing agent in the dampening unit 5 and in the anilox inking unit 4 may be achieved if the outside diameter d1 of the dampener applicator roller 20 amounts to less than 50% of the outside diameter D of the ink applicator roller 7. Preferably, the outside diameter d2 of the bridge roller 22 should also amount to less than 50% of the outside diameter D of the ink applicator roller 7.

Tests have established that the distribution of the washing agent is particularly uniform when the outside diameters d1, d2 of the dampener applicator roller 20 and of the bridge roller 22 respectively amount at most to 40% of the outside diameter D of the ink applicator roller 7. Additionally, the dampener distributor roller 21 may have an outside diameter, the extent of which is less than 50% and preferably at most 40% of the outside diameter D of the ink applicator roller 7. With such dimensioning, the respective roller 20, 21, 22 executes at least two revolutions for each revolution of the ink applicator roller 7. The advantages of this dimensioning are manifested in a positive way not only during the entry of the washing agent, but also during the entry of the ink when the printing ink is introduced from the anilox inking unit 4 into the dampening unit 5 by the rollers 7, 20, 22.

Due to the selected roller diameter relationship, the intrusion or disturbance caused by the cylinder channel 29 of the ink applicator roller 7 can no longer lead to complications detectably impairing the print quality, wherein an additional advantage may be seen.

As soon as the washing agent has arrived in sufficient quantity at the third roller 10, the cleaning doctor blade 24 is thrown onto the third roller 10, and the printing ink/washing agent mixture is wiped off the third roller 10. The wiped-off printing ink/washing agent mixture is collected in the collecting trough 25. During the wipe-off, fresh washing agent continues to be sprayed into the dampening unit 5.

The operator of the printing machine 1 can selectively set the “clean the printing form cylinder” program on the latter, so that, within the hereinafore-described cleaning operation, the ink applicator roller 7 is thrown onto the printing form cylinder 2, as is illustrated in the drawing. In this regard, the ink applicator roller 7, during the cleaning mode, bears against the screen roller 6 and, simultaneously, against the printing form cylinder 2. In this manner, the washing agent passes not only from the dampener applicator roller 20 onto the ink applicator roller 7 over the bridge roller 22, but also from the ink applicator roller 7 onto the printing form cylinder 2.

At the end of the cleaning operation, the supply of washing agent is initially terminated, somewhat later the cleaning doctor blade 24 is thrown off of the third roller 10 and thereafter, the metering roller 19 is thrown onto the dampener applicator roller 20 and the latter is thrown onto the printing form cylinder 2, in order to scavenge the latter with the dampening medium from the dampening unit 5 before the start of the printing operation.

We claim:

1. A sheet-fed printing machine, comprising:
an anilox inking unit including a screen roller and an ink applicator roller, said ink applicator roller having an outside diameter; and
a dampening unit including a dampener applicator roller having an outside diameter;
said outside diameter of said ink applicator roller being more than twice as large as said outside diameter of said dampener applicator roller.

2. The sheet-fed printing machine according to claim 1, wherein said respective outside diameters of said ink applicator roller and said dampener applicator roller are in a ratio of at least 10:4.

3. The sheet-fed printing machine according to claim 1, which further comprises a bridge roller bearing against said dampener applicator roller and against said ink applicator roller in a cleaning mode.

4. The sheet-fed printing machine according to claim 3, wherein said bridge roller has an outside diameter, and said outside diameter of said ink applicator roller is more than twice as large as said outside diameter of said bridge roller.

5. The sheet-fed printing machine according to claim 4, wherein said outside diameter of said ink applicator roller and said outside diameter of said bridge roller are in a ratio of at least 10:4.

6. The sheet-fed printing machine according to claim 1, which further comprises a device selected from the group consisting of a jet device and a spray device for introducing a washing agent directed onto said dampening unit.

7. The sheet-fed printing machine according to claim 6, which further comprises a dampening unit roller bearing only against said dampener applicator roller, said device selected from the group consisting of a jet device and a spray device being directed onto at least one of said dampener applicator roller and said dampening unit roller bearing only against said dampener applicator roller.

8. The sheet-fed printing machine according to claim 1, which further comprises at least one inking unit roller, and a cleaning doctor blade coupled to said screen roller through said at least one inking unit roller in a cleaning mode.

9. The sheet-fed printing machine according to claim 1, wherein said ink applicator roller is formed with a cylinder channel provided with a tensioning device for mounting a rubber blanket in tension on said ink applicator roller.

10. The sheet-fed printing machine according to claim 1, which further comprises a printing form cylinder having an outside diameter being identical to said outside diameter of said ink applicator roller.
